(19) United States
(12) Patent Application Publication
(10) Pub. No.: US 2006/0152490 A1
(43) Pub. Date: Jul. 13, 2006

(54) Casing structure of mouse

(75) Inventors: Yu Wen Ho, Taipei (TW); Ye Lo, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/298,528

(22) Filed: Dec. 12, 2005

(30) Foreign Application Priority Data
Jan. 13, 2005 (TW) 094101051

(51) Int. Cl. G09G 5/08

(52) U.S. Cl. 345/163

(57) ABSTRACT

A casing structure of a mouse includes a base, an upper cover, and a soft pad. The upper cover is disposed on the base to form an accommodating space. The soft pad covers the upper cover.

### BACKGROUND OF THE INVENTION

1. Field of Invention

The invention relates to a casing structure and, in particular, to a casing structure of a mouse.

2. Related Art

The mouse is one of the basic computer peripherals as the operating interface between the user and the computer. By moving the position of the mouse with hand, the user can arbitrarily change the position of the mouse cursor on the computer screen. By simply clicking the buttons on the mouse, the user can input a command to control the computer. Therefore, the mouse has become an indispensable communication tool between users and computers.

With reference to FIG. 1, a casing 10 of the mouse 1 has a base 11 and an upper cover 12. A user moves the mouse 1 a distance to roll a rolling ball 13 in the base 11. A sensing switch 16 detects the moving distance along first axis 14 (x-axis) and a second axis 15 (y-axis), so that the mouse cursor accordingly moves in the x and y directions on the screen.

Herein, the upper cover 12 is a slant-curved surface for a palm and fingers to hold. The front end of the upper cover 12 is provided with a button part 121 for fingertips to enter commands.

In practice, the user can use one palm of both hands to operate the mouse. However, the mouse usually provides the casing 10 with a fixed curved surface. Therefore, it is hard to fit the palm and fingers to the upper cover 12 of the mouse perfectly during operating. For habitually practicing of different users, the manufacturers have to make make different kinds of mouse casings 10 with curved surfaces for left and right hands. The production cost is inevitably increased.

Moreover, if the user cannot have a close contact between his/her palm and the casing 10, the hand muscle may be uncomfortable and eventually lead to injury of the sinew. This does not only affect how the user will use the mouse, but also results in great trouble in health and life.

In view of the above-mentioned problems, we provide a casing structure of a mouse to achieve better contact between the palm and the mouse casing.

### SUMMARY OF THE INVENTION

In view of the above, the invention is to provide a casing structure of a mouse with a soft pad, so that the palm has a close contact with the casing.

To achieve the above-mentioned, the casing structure of the mouse according to one embodiment of the invention includes a base, an upper cover, and a soft pad. The upper cover is disposed on the base to form an accommodating space. The soft pad covers the upper cover.

The disclosed casing structure of the mouse has a soft pad. In comparison with the prior art, the embodiment of the invention allows a full contact between the user's palm and the casing of the mouse. This can prevent hand muscles from injuries due to incomplete contact. Therefore, the disclosed mouse is more ergonomic and comfortable. Furthermore, the soft pad provides the user a better touch feeling and the consumers are thus more willing to purchase. Besides, the manufacturers do not need to separately fabricate casings for left- and right-handed users. Using the soft pad provided on the upper cover, the disclosed mouse can be conveniently used by any person. This greatly reduces the production cost.

### BRIEF DESCRIPTION OF THE DRAWINGS

The invention will become more fully understood from the detailed description given hereinbelow illustration only, and thus are not limitative of the present invention, and wherein:

FIG. 1 is a schematic diagram showing a mouse in the prior art;

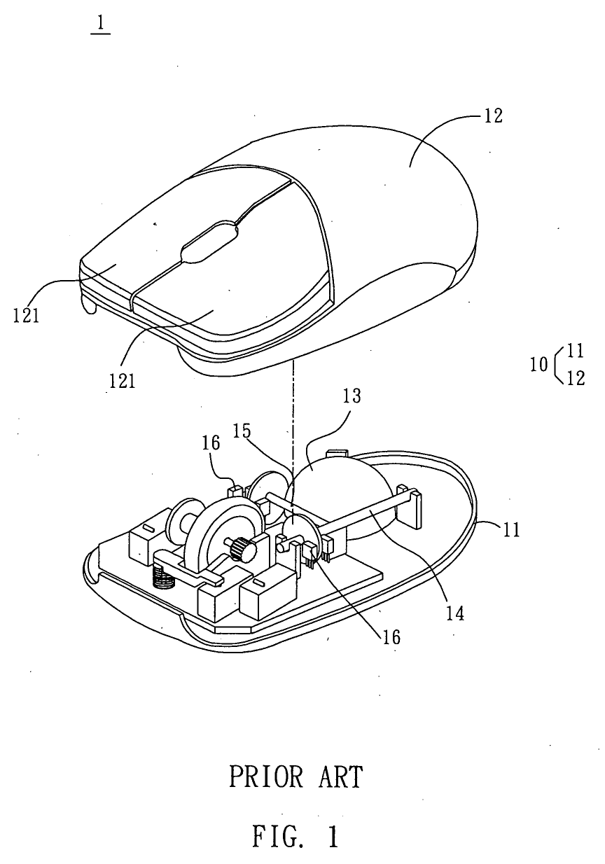

FIG. 2 is a schematic diagram showing a casing structure of a mouse according to the first embodiment of the invention.

FIG. 3 is a schematic diagram showing a base, a button member, and an upper cover according to the first embodiment of the invention.

FIG. 4 is a schematic diagram showing a casing structure of a mouse according to the second embodiment of the invention.

FIG. 5 is a schematic diagram showing a casing structure of a mouse according to the third embodiment of the invention.

### DETAILED DESCRIPTION OF THE INVENTION

The casing structure of the mouse according to the preferred embodiments of the invention will be described with reference to the relevant drawings.

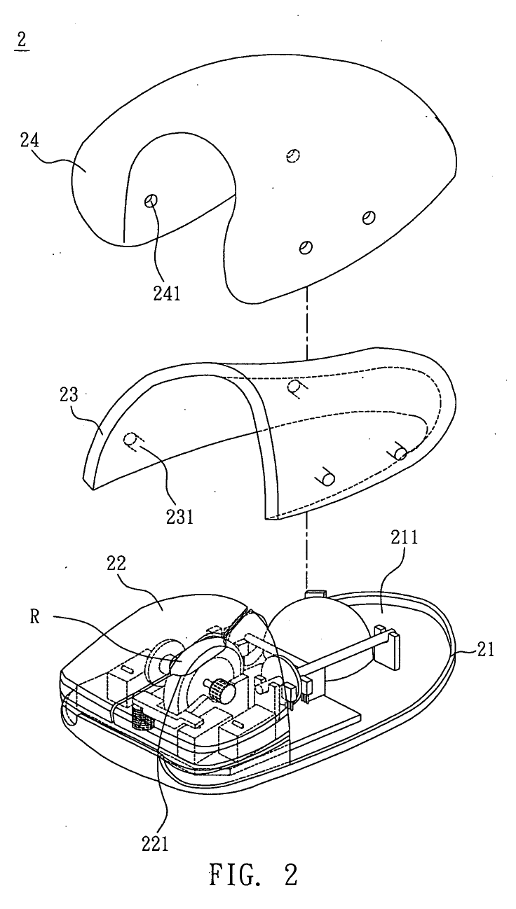

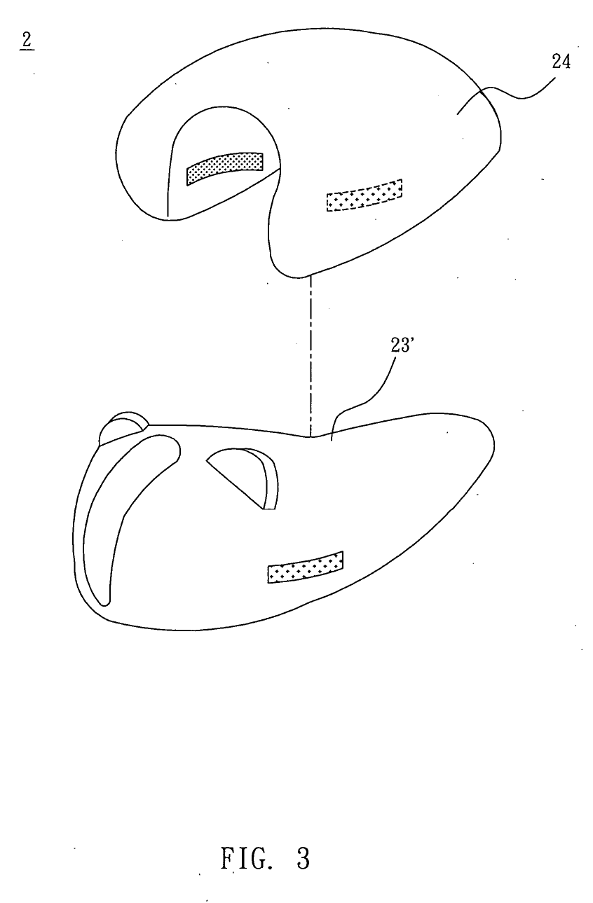

Please refer to FIGS. 2 and 3, a first embodiment of a casing structure of a mouse is disclosed.

As shown in FIG. 2, the casing structure of the mouse 2 includes a base 21, an upper cover 23, and a soft pad 24.

The upper cover 23 is disposed on the base 21 to form an accommodating space 211. The accommodating space 211 is used to hold the internal mechanical structure of the mouse, such as the track ball, grating, and circuit board. In this embodiment, the upper cover 23 may be made of plastic. The supporting force provided by the upper cover 23 supports the soft pad 24.

In the current embodiment, the casing structure of the mouse 2 further includes a button member 22 installed on the base 21 and matching with the upper cover 23. In particular, the base 21 and the button member 22 can be integrally formed through an ejection process. The button member 22 may have an opening 221 for exposing the roller R of the mouse.

Please refer to FIG. 3 for a schematic view of the base, the button member, and the upper cover of the disclosed casing structure of mouse. The upper cover 23 in FIG. 2 may be integrally formed with the button member 22, forming the casing 23′ in FIG. 3 to enclose the mechanical structure of the mouse. Therefore, the casing 23′ may be designed to attract the consumers (e.g. in the shape of animals).

With further reference to FIG. 2, the upper cover 23 has a first combining portion 231, such as part of a Velcro set, a protruding part, or some other clipping portions. In the drawing, we take a protruding part as an example for the combination of the upper cover 23 and the soft pad 24.

The soft pad 24 covers at least one part of the upper cover 23. The soft pad 24 may be latex, sponge, foam, memory material, or some other soft materials. In this embodiment, the soft pad 24 has a second combining portion 241 for the combination with the first combining portion 231 of the upper cover 23. The second combining portion 241 can be part of a Velcro set, a hole, or some other clipping portions. Of course, the combination between the first combining portion 231 and the second combining portion 241 may be through the hole on the first combining portion 231 and the protruding part of the second combining portion 241. They can be combined with the help of an adhesive too.

When the user uses the mouse, his/her palm rests on the soft pad 24. With the soft buffering material of the soft pad 24, the palm can have close contact with the casing of the mouse. Therefore, the mouse is more ergonomic and provides a better hold. Moreover, the material of the soft pad 24 has some micro-memory function to remember the user's hand shape. This function can avoid hand discomfort and possible injuries.

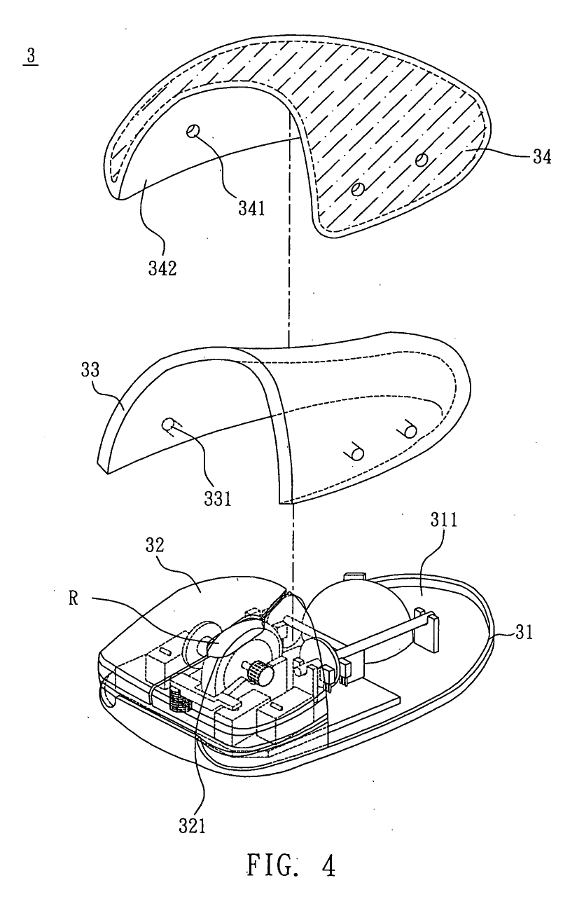

Please refer to FIG. 4 for a schematic view of a second embodiment of a casing structure of a mouse. It is seen from the drawing that the casing structure of the mouse 3 with micro memory includes a base 31, an upper cover 33, and a soft pad 34.

In this embodiment, the casing structure of the mouse 3 may further include a button member 32 disposed on the base 31 and matching with the upper cover 33. Since the base 31, the button member 32, and the upper cover 33 are the same as the base 21, the button member 22, and the upper cover 23 in the first embodiment, we do not repeat herein.

In FIG. 4, the soft pad 34 is a soft bag filled with a fluid. In the current embodiment, the material of the soft pad 34 may be thermo-forming plastic (e.g. polyurethane) formed by a stamping or ejection process. The fluid filled inside the soft pad 34 may be a gel (e.g. silicon gel) or a liquid (e.g. water). Moreover, the soft pad 34 may have a hard bottom 342, which sustains a firm combination with the upper cover 33.

The soft pad 34 has a second combining portion 341, disposed on the hard bottom 342 for the combination with the first combining portion 331 of the upper cover 33. In this embodiment, the first combining portion 331 and the second combining portion 341 are the same as the first combining portion 231 and the second combining portion 241 of the first embodiment in functions and features. Therefore, we do not repeat their description here.

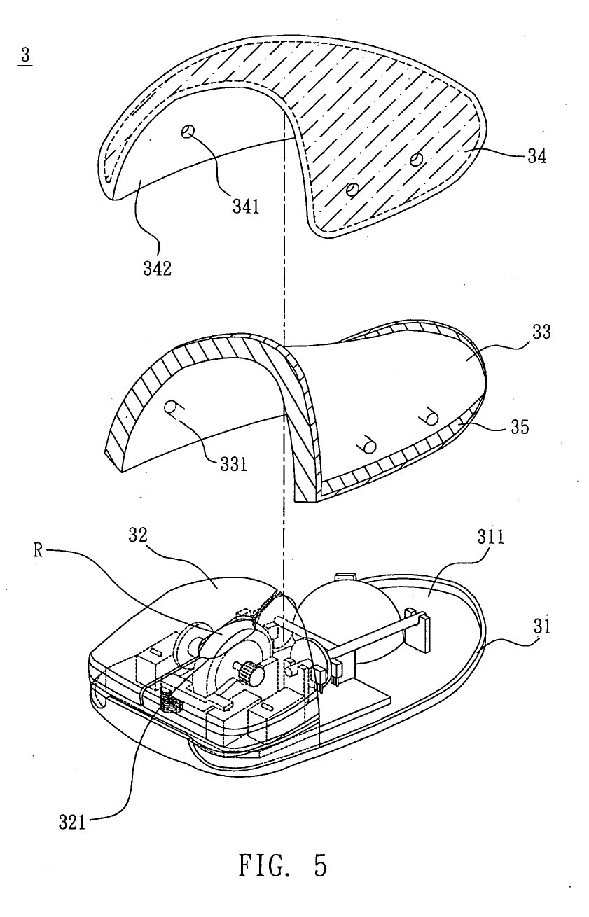

FIG. 5 shows a schematic view of the third embodiment of a casing of a mouse 3. In this embodiment, the casing structure further includes a limiting member 35 mounted around the upper cover 33. It touches against and helps positioning the soft pad 34. The limiting member 35 can be a plastic frame.

In conclusion, the disclosed casing structure of mouse has a soft pad. In comparison with the prior art, the invention allows a full contact between the user's palm and the mouse casing. This can prevent hand muscles from injuries due to incomplete contact. Therefore, the disclosed mouse is more ergonomic and comfortable. Furthermore, the soft pad provides the user a better touch feeling; and the consumers are thus more willing to purchase. Besides, the manufacturers do not need to separately fabricate casings for left- and right-handed users. Using the soft pad provided on the upper cover, the disclosed mouse can be conveniently used by any person. This greatly reduces the production cost.

Certain variations would be apparent to those skilled in the art, which variations are considered within the spirit and scope of the claimed invention.

What is claimed is:

1. A casing structure of a mouse, comprising:
a base;
an upper cover, which is disposed on the base to form an accommodating space; and
a soft pad, which covers the upper cover.

2. The casing structure of claim 1, further comprising a button member disposed on the base and matching with the upper cover.

3. The casing structure of claim 2, wherein the base and the button member are integrally formed.

4. The casing structure of claim 2, wherein the upper cover and the button member are integrally formed.

5. The casing structure of claim 1, wherein the material of the upper cover is plastic.

6. The casing structure of claim 1, wherein the upper cover has a first combining portion for the combination with the soft pad.

7. The casing structure of claim 1, wherein the soft pad is made of a material selected from the group consisting of latex, sponge, foam, and memory materials.

8. The casing structure of claim 6, wherein the soft pad has a second combining portion for the combination with the first combining portion.

9. The casing structure of claim 8, wherein the first combining portion and the second combining portion are a Velcro set.

10. The casing structure of claim 8, wherein the first combining portion is a protruding part and the second combining portion is a hole.

11. The casing structure of claim 1, wherein the soft pad is a soft bag filled with a fluid.

12. The casing structure of claim 11, wherein the fluid is selected from the group consisting of a gel and a liquid.

13. The casing structure of claim 11, wherein the upper cover has a first combining portion for the combination with the soft bag.

14. The casing structure of claim 11 further comprising a limiting member mounted around the upper cover to touch against the soft bag.

15. The casing structure of claim 14, wherein the limiting member is a plastic frame.

16. The casing structure of claim 13, wherein the soft bag has a second combining portion for the combination with the first combining portion.

17. The casing structure of claim 16, wherein the first combining portion and the second combining portion are a Velcro set.

18. The casing structure of claim 16, wherein the first combining portion is a protruding part and the second combining portion is a hole.
